(19) United States
(12) Patent Application Publication
(10) Pub. No.: US 2003/0007019 A1
(43) Pub. Date: Jan. 9, 2003

(54) Chart recorder programming interface

(76) Inventor: Matthew Levine, Boca Raton, FL (US)

Correspondence Address: John G. Posa, Gifford, Krass, Groh, Suite 400, 280 N. Old Woodward Ave., Birmingham, MI, 48009, US

(21) Appl. No.: 09/900,787

(22) Filed: Jul. 6, 2001

(51) Int. Cl. G01D 9/00

(52) U.S. Cl. 346/23

(57) ABSTRACT

A chart recorder or other applicable instrument uses the chart or other recording medium for programming purposes, thereby obviating the need for additional keypads and/or displays. By placing this chart onto the recorder, and by moving the pen to select among the available options, the unit is automatically programmed in accordance with the selections, without the need for controls other than those used for pen and/or chart movement. Since the position of the chart is known due to the spatial alignment with the start position, and the position of the marker is always known, selection of the programming features is unambiguous according to the invention. In addition to circular chart recorders, the invention applies to strip-chart recorders, plotters, printers, and other pieces of equipment wherein the position of a marker and/or paper or other substrate is known or determinable. An advantage of the invention is that the chart is produced in confirmation of the settings, thereby leaving a user or operator with a printed record of the way in which the chart was programmed. In the preferred embodiment, a chart is provided having a comprehensive list of certain options imprinted thereon, whereby the user moves the pen so as to strike out those options which the user does not choose, thereby leaving the options which are undesirable. Alternatively, however, the pen may be used to select desired options, as to underlining, for example, without affecting undesired options.

### FIELD OF THE INVENTION

This invention relates generally to chart recorders of the type used to monitor temperature, humidity, vibration, and so forth, and, in particular, to apparatus and methods which allow a user to more easily program such units.

### BACKGROUND OF THE INVENTION

Although chart recorders have been commercially available for many years, they remain necessary in many applications, including the monitoring of temperature, humidity, vibration, and other conditions, particularly over prolonged periods of time. For this reason, chart recorders are used in various situations, including the monitoring of temperature/humidity in museums, environmental monitoring of blood products in hospital settings, and so forth. In these and other applications, chart recorders are the best instruments to certify the processes which they are used to measure.

Although chart recorder operation has remained essentially the same for quite some time, numerous features have been added, requiring a user to program the unit to record at a particular scale or time sequence, to recognize the password of particular users, and other settings. Existing units are programmed in much the same way that other pieces of electronic equipment are programmed, namely, by entering commands through some form of keypad, with results being displayed on some form of alphanumeric readout.

This type of chart recorder programming currently in use has at least two disadvantages. For one, separate keypads and displays are relatively expensive items, precluding product applicability to certain very cost-sensitive markets. The addition of keypads and displays also adds further components which could break down, resulting in maintenance issues. Secondly, even with a dedicated keypad and display, programming sequences may be complicated and difficult to understand, leading to prolonged procedures, and possible operator error.

The need remains, therefore, for a chart recorder which is more easily programming while, at the same time, utilizes a human interface which does not substantially raise costs.

### SUMMARY OF THE INVENTION

This invention improves upon the prior art by providing a chart recorder which uses the chart itself for programming purposes, thereby obviating the need for additional keypads and/or displays. Although the invention is described in terms of a circular chart recorder, the concept is not limited in this regard, and may apply to strip-chart recorders, plotters, printers, and other pieces of equipment wherein the position of a marker and/or paper or other substrate is known or determinable.

Broadly, using a circular chart recorder as an example, a chart is provided having indicia printed in predetermined locations on the chart, such indicia having to do with the programming of the recorder. By placing this chart onto the recorder, and by moving the pen to select among the available options, the unit is automatically programmed in accordance with the selections, without the need for controls other than those used for pen and/or chart movement. Another advantage of the invention is that the chart is produced in confirmation of the settings, thereby leaving a user or operator with a printed record of the way in which the chart was programmed. A programming log may also be stored, preferably in a non-volatile memory such as an EE-PROM, and printed out for verification or archival purposes.

In the preferred embodiment, a chart is provided having a comprehensive list of certain options imprinted thereon, whereby the user moves the pen so as to strike out those options which the user does not choose, thereby leaving the options which are undesirable. Alternatively, however, the pen may be used to select desired options, as to underlining, for example, without affecting undesired options.

Although a chart which moves into two directions is desirable, such a feature is not necessary to the invention, since unidirectional chart movement in conjunction with pen movement may be used to access any appropriate portion of the chart for programming purposes. Although a specialized chart is preferably provided for programming, each chart actually used may also have programming indicia imprinted thereon, preferably using a lighter shade that does not interfere with scale markings. An overlay or encoded matrix may also be used. In any case, since the position of the chart is known due to the spatial alignment with the start position, and the position of the marker is always known, selection of the programming features is unambiguous according to the invention.

### BRIEF DESCRIPTION OF THE DRAWING

FIG. 1 is a drawing of a set-up chart according to the invention enabling a user to program a recorder using chart and pen movement controls.

### DETAILED DESCRIPTION OF THE INVENTION

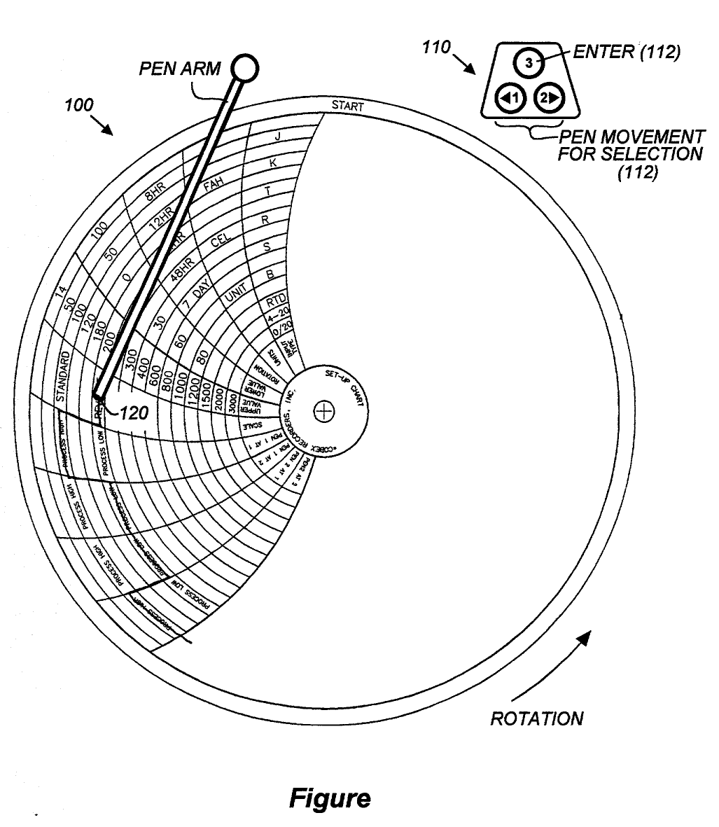

FIG. 1 is a drawing which shows a set-up chart 100 placed on a chart recorder according to the invention, having controls 110 including one or more buttons 112 used to effectuate chart rotation and one or more buttons 114 used to effectuate pen movement. The pen is shown at 120. On the chart, preferably near the center hole, there is imprinted a series of programming features, including pen placement for process low/high conditions, scale (standard or reverse), upper value, lower value rotation units, and input type. This particular list of programming features is not critical to the invention, and that more or fewer criteria may be added or deleted, depending upon the type of chart and/or environment to be monitored.

Using the pushbuttons to rotate the chart and move the pen, in accordance with the direction of rotation shown, the user has moved the pen to delete portions that are not desired, leaving the unit to be programmed such that process low occurs with pen 2 at 2, process high occurs with pen 2 at 1 and pen 1 at 2, process low occurs with pen 1 at 1, and the scale is standard as opposed to reverse. Other features of recording such as upper value, lower value, rotation units and input type have yet to be programmed.

It will be appreciated that the invention is made possible by the fact that in many devices of this type, the position of the pen on a chart is either known or ascertainable in one or two dimensions by indexing the chart or other recording medium and stylus movement to initial or start positions. Once a chart, for example, has been initialized in this way, movement of the pen at any particular point of the chart is known through stored position data, enabling a correlation between pen position and programming indicia to be determined and stored.

Although a “set-up chart” is shown, it should also be evident that the chart actually used for recording may also be used for programming purposes, with the visual indicia being printed in a faint manner so as not to interfere with the actual recording. As an alternative, an overlay, blank chart, or non-set-up chart may be used in conjunction with a chart containing the visual indicia to determine programming features by looking through both substrates in overlying registration.

One advantage of the invention is that a written record is produced of programming functions following movement of the pen and/or chart through the procedure described herein. In addition to providing a written record at the time that the unit is first programmed, as an alternative feature, a chart may be placed on the unit and a replay sequence is entered, as through keypad 110, to read out the programming sequence, so that one unaware of what the program parameters are may immediately be informed with respect thereto.

In addition to the programming features described, the following list includes other possible parameters applicable to the invention, with the understanding that this list is not exhaustive:

Date

Time of day

Controller parameters (e.g., ramp, scale, tuning) PID valves

Timer functions

Math functions (e.g., totalizer, square root)

Event messages

Password/lockout

Communication/output

Calibration

I claim:

1. A method of programming an instrument of the type wherein a marking implement is used to mark a surface, the method comprising the steps of:
providing a surface including visible options relating to the programming of the instrument;
storing information relating to the location of surface positions accessible by the marking implement;
moving at least the marking implement relative to the visible options for selection purposes; and
programming the instrument by correlating the position of the implement during the movement thereof to determine the options selected.

2. The method of claim 1, wherein the step of moving at least the implement includes moving the implement in two dimensions.

3. The method of claim 1, further including the step of moving the surface relative to the implement during the selection process.

4. The method of claim 1, wherein the instrument is a chart recorder and the surface is on a chart.

5. The method of claim 4, wherein the chart is a circular chart.

6. The method of claim 1, wherein the options relate to one or more of the following:
date or time,
the operation of an external controller,
a mathematical function,
an event message,
the function of a communications channel, or
the calibration of the instrument.

7. The method of claim 1, further including the step of indexing the surface relative to a start position in conjunction with the step of storing information relating to the location of surface positions accessible by the marking implement.

8. The method of claim 1, wherein the options are selected by marking the surface with the implement.

9. The method of claim 8, wherein the options are selected by underscoring, circling or otherwise highlighting desired options, or by striking out undesired options.

10. The method of claim 1, further including the step of marking a new surface in response to a user command subsequent to the programming of the instrument to obtain a record of currently selected options.

11. A method of programming a chart recorder having a pen to mark a chart, comprising the steps of:
providing a chart including printed parameters relating to the programming of the recorder;
placing the chart in a start position, enabling the recorder to advance to known positions on the chart using movements of the pen, chart, or both;
moving at least the pen relative to the printed parameters so as to select certain of the parameters by marking the chart with the pen; and
programming the recorder by correlating the position of the pen relative to the chart during the selection of the parameters.

12. The method of claim 11, wherein the known locations on the chart are in two dimensions.

13. The method of claim 11, wherein the chart is a circular chart.

14. The method of claim 11, wherein the printed parameters relate to one or more of the following:
date or time,
the operation of an external controller,
a mathematical function,
an event message,
the function of a communications channel, or
the calibration of the instrument.

15. The method of claim 11, wherein the parameters are selected by underscoring, circling or otherwise highlighting desired parameters, or by striking out undesired parameters.

16. The method of claim 11, further including the step of marking a new chart in response to a user command subsequent to the programming of the instrument to obtain a record of currently selected options.
